(19) United States
(12) Patent Application Publication
(10) Pub. No.: US 2011/0010235 A1
(43) Pub. Date: Jan. 13, 2011

(54) Method and System for Setting an Online Coupon Cookie

(75) Inventor: Jeff Kenny, Chicago, IL (US)

Correspondence Address: MARSHALL, GERSTEIN & BORUN LLP, 233 SOUTH WACKER DRIVE, 6300 WILLIS TOWER, CHICAGO, IL, 60606-6357, US

(73) Assignee: CouponCabin, Inc., Chicago, IL (US)

(21) Appl. No.: 12/833,637

(22) Filed: Jul. 9, 2010

Related U.S. Application Data
(60) Provisional application No. 61/301,374, filed on Feb. 4, 2010.

(51) Int. Cl. G06Q 30/00

(52) U.S. Cl. 705/14.23

(57) ABSTRACT

A clickable object may obscure a coupon code on an affiliate's website to prevent a user from memorizing or otherwise copying the coupon code and using the code in an online sale transaction without setting a web browser cookie. Upon visiting the affiliate's website, the user may select or click the obscuring clickable object to reveal the coupon code. The user's action of selecting the obscuring clickable object may set the cookie in the user's web browser and ensure that the affiliate receives credit for referring the user to the retailer.

### CROSS-REFERENCE TO RELATED APPLICATIONS

This application claims the benefit of U.S. patent application Ser. No. 61/301,374 that was filed on Feb. 4, 2010 entitled “METHOD AND SYSTEM FOR SETTING AN ONLINE COUPON COOKIE.” U.S. patent application Ser. No. 61/301,374 is entirely incorporated by reference herein.

### TECHNICAL FIELD

The present disclosure generally relates to a system and method for ensuring that a provider of online discount codes or “coupons” for online retailers receives credit for coupons obtained from the provider's website, and, more particularly, for ensuring that a browser cookie that identifies the coupon provider to the retailer and to other participants in an online sale transaction is set before a shopper is able to apply the coupon to an online purchase.

### BACKGROUND

Online retailers have employed various methods to draw shoppers to their websites, including methods that have their origin in traditional, “brick and mortar” sales transactions. One method is the use of discounts in the form of coupons. Traditional coupons are offered to a potential customer through printed circulars, newspaper supplements, magazine advertisements, etc., and usually offer some sort of discount off of the regular sale price of an item. Bar codes on the printed coupons allow the retailer and manufacturer to track various information about the sale including the origin of the printed coupon (i.e., the newspaper, magazine, or other physical source of the coupon). By tracking information about the source of the coupon, the retailer or manufacturer may also provide a commission from the sale of the item to the coupon publisher as motivation to publish future coupons.

Coupons are also used in online sales transactions. Sales commissions may be earned by entities that publish, aggregate, and maintain online coupon codes or discount URLs or “links” through affiliate marketing. One example of an online coupon system includes U.S. patent application No. 11/746,384 entitled “System and Method for Sharing Revenue Resulting from Online Coupon Use” filed on May 9, 2007, the entire disclose of which is incorporated by reference herein. In an affiliate marketing relationship, a retailer or other online business rewards one or more third parties or “affiliates” for a sale transaction that originates by the affiliate's marketing efforts. Affiliate marketing typically includes four entities: a retailer, a network, a publisher or affiliate, and a customer. Affiliate networks partner with publishers who provide online coupon codes or discount links to help draw more customers to the retailers. In essence, a retailer will pay a sales commission to one or more of the network and the affiliate for directing potential customers to the retailer's website to complete a sale transaction. For example, online retailers may use the Google Affiliate Network, LinkShare, Commission Junction, or others to connect advertisers and publishers to increase sales and sales leads. This increased traffic leads to more sales using the retailer's website and is directly attributable to the effort of the network and the affiliate.

The network and affiliate are able to realize a sales commission if the retailer is able to directly credit a sale to those entities. The retailer, network, and affiliate are able to track the origin of the sale by using web browser cookies. Cookies are small pieces of text stored on a user's computer by the user's web browser. A cookie is made up of one or more name-value pairs containing bits of information. When a user requests information from a web server, the name portion of the cookie is set by the server that receives that web request and the value portion is a random value that allows identification of the requestor. In an online sale transaction involving an affiliate network, the cookie may include information that identifies both the affiliate network and the affiliate to the retailer. A cookie becomes active or “set” by the requested web server when the user initiates a web request. For example, a user may select or “click” an online coupon code or discount link that is published on an affiliate's web site which launches an affiliate referral process. The affiliate referral process activates a cookie sent from the affiliate network that identifies the affiliate on a web-enabled device. The affiliate network, in turn, sends a web request to the retailer's server and redirects the user's browser to the retailer's site. The retailer server may then set another cookie on the user's web-enabled device identifying both the affiliate and the affiliate network. When the user accesses the retailer's site associated with the code, the retailer's web server may read the cookie with the retailer's domain on the user's web enabled device in order to identify one or more of the affiliate and the affiliate network to the retailer.

Typically, a user visits an affiliate's website (e.g., CouponCabin.com) by entering the affiliate's URL directly into the user's browser, by a search engine, by following a link in an email, etc. The user may find a discount link or coupon code for a retailer and then select or click that link or code that includes a request URL. Selecting the link or coupon sends the user's browser to the affiliate network's server along with an identifying code contained in the request URL indicating that the affiliate was the referral source. The affiliate network's server/redirector sets a cookie on the user's computer that identifies the affiliate and the affiliate network to the retailer. The user's browser then redirects to the retailer's web site. The user shops at the retailer's site and as part of the checkout process, the customer may enter the coupon code in an appropriate field. Upon completion, the sale is logged to a server at the affiliate network and the affiliate network reports the completed transaction back to its source: the affiliate. The affiliate may earn a percentage commission on the sale according to terms agreed to with the retailer because the retailer was able to identify the affiliate from the information contained in the cookie.

However, because the coupon codes are plainly visible short strings of text, it is possible that, instead of clicking the discount link or coupon code to set the cookie on the user's browser, a user may simply memorize the code from the affiliate's site and manually type the code into the appropriate field on the checkout web page at the retailer's website. Typing in the code without clicking on the code on the affiliate's web site bypasses the entire affiliate referral process discussed above and prevents the affiliate and the affiliate network from earning a sales commission it would have otherwise received.

### SUMMARY

To prevent the user from memorizing the coupon code from the affiliate's website and using it in an online sale transaction without setting the web browser cookie, a clickable object may obscure the coupon code on the affiliate's site. Upon visiting the affiliate's website, the user may select or click the obscuring clickable object to reveal the coupon code. The user's action of selecting the obscuring clickable object may set the cookie in the user's web browser and ensure that the affiliate receives credit for referring the user to the retailer.

### BRIEF DESCRIPTION OF THE DRAWINGS

FIG. 1 illustrates an exemplary block diagram of a computer network and system on which an exemplary coupon code referral tracking system and method may operate in accordance with the described embodiments;

FIG. 2 illustrates an exemplary block diagram of a flow chart for one embodiment of a method for ensuring that a cookie is set to track the source of referrals to retailer websites;

FIG. 3A illustrates an exemplary screen shot of a clickable object for use in an exemplary coupon hosting system or “affiliate” as described herein;

FIG. 3B illustrates another exemplary screen shot of the clickable object and a mouse over function of the clickable object;

FIG. 3C illustrates another exemplary screen shot of a web page of the coupon hosting system after the clickable object has been selected to reveal the coupon codes;

FIG. 4 illustrates a further exemplary block diagram of a flow chart continued from FIG. 2 for one embodiment of a method for ensuring that a cookie is set to track the source of referrals to retailer websites;

FIG. 5 illustrates an exemplary screen shot of an online retailer web page after being redirected from a coupon code hosting system web page;

FIG. 6 illustrates another exemplary screen shot of an online retailer web page after being redirected from a coupon code hosting system web page including a coupon code field; and

FIG. 7 illustrates a further exemplary block diagram of a flow chart continued from FIG. 2 for tracking the referral source once the transaction is complete.

### DETAILED DESCRIPTION

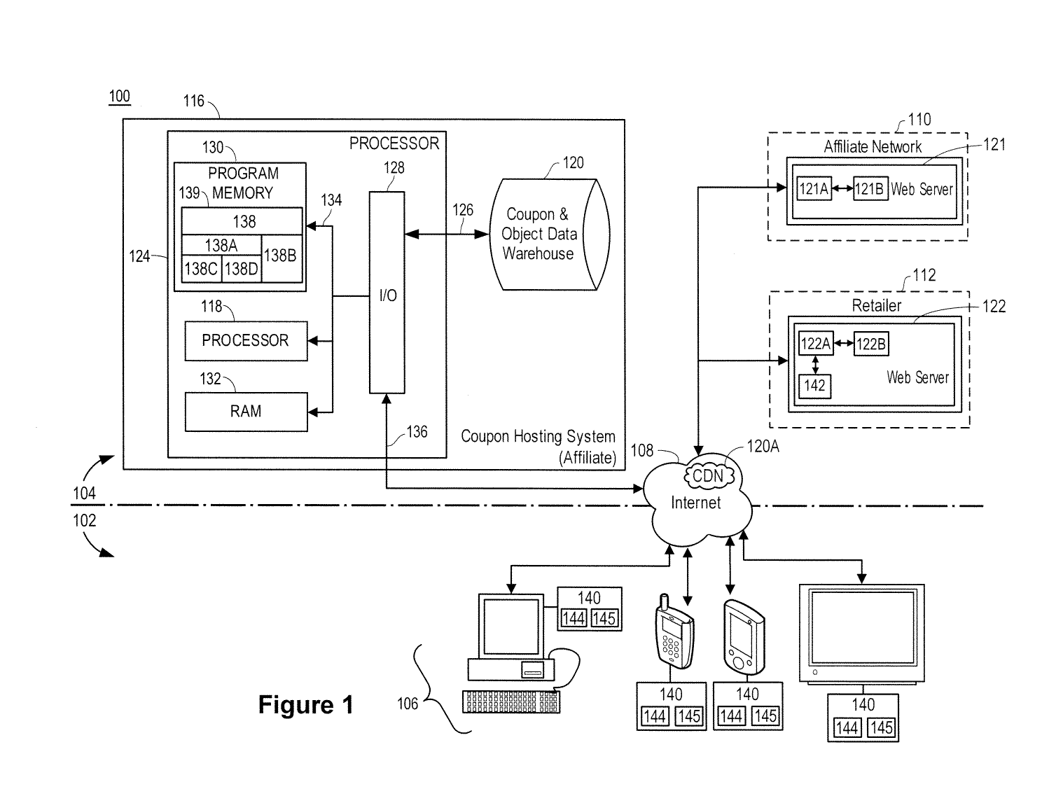

FIG. 1 illustrates various aspects of an exemplary architecture implementing an online coupon code referral tracking system 100. In particular, FIG. 1 illustrates a block diagram of the exemplary online coupon code referral tracking system 100. The high-level architecture includes both hardware and software applications, as well as various data communications channels for communicating data between the various hardware and software components. The online coupon code referral tracking system 100 may be roughly divided into front-end components 102 and back-end components 104. The front-end components 102 are primarily web-enabled devices 106 (personal computers, smart phones, PDAs, televisions, etc.) connected to the internet 108 by one or more users. The web-enabled devices 106 may be located, by way of example rather than limitation, in separate geographic locations from each other, including different areas of the same city, different cities, or even different states.

The front-end components 102 communicate with the back-end components 104 via the Internet or other digital network 108. In some embodiments, the web-enabled devices 106 may communicate with the back-end components via the Internet 108. The digital network 108 may be a proprietary network, a secure public Internet, a LAN, a virtual private network or some other type of network, such as dedicated access lines, plain ordinary telephone lines, satellite links, combinations of these, etc. Where the digital network 108 comprises the Internet, data communication may take place over the digital network 108 via an Internet communication protocol. The back-end components 104 include a coupon hosting system 116 or “affiliate” such as CouponCabin.com or other internet-based, publicly-accessible system, an affiliate network 110, and a retailer 112. Additionally or alternatively, the coupon hosting system 116 may be web server in communication with a private or secure LAN. The coupon hosting system 116 may include one or more computer processors 118 adapted and configured to execute various software applications, modules, functions, routines, and components of the online coupon code referral tracking system 100. These various applications, etc., may, in addition to other software applications, allow an affiliate to receive credit for referring customers to a retailer's website, as further described below. The coupon hosting system or web server 116 further includes a data warehouse or database 120. The data warehouse 120 is adapted to store coupon codes, discount uniform resource locators (URLs), and other content to be hosted by the coupon hosting system 116 and displayed on a website. The coupon hosting system 116 may access data stored in the data warehouse 120 when executing various functions and tasks associated with the operation of the online coupon code referral tracking system 100, as described herein.

Although the online coupon code referral tracking system 100 is shown to include a coupon hosting system 116 in communication with three web enabled devices 106, an affiliate network 110 and a retailer 112, it should be understood that different numbers of processing systems, computers, users, affiliate networks, and retailers may be utilized. For example, the Internet 108 may interconnect the system 100 to a plurality of coupon hosting systems, other affiliate networks 110, retailers 112, and a vast number of web-enabled devices 106. According to the disclosed example, this configuration may provide several advantages, such as, for example, enabling near real-time updates of coupon codes from the retailers 112, changes to the discount links or coupons from the retailers 112, as well as periodic uploads and downloads of information. Both the affiliate network 110 and retailer 112 may include one or more web servers 121, 122, respectively. The affiliate network web server 121 may include information, applications, modules, routines, instructions, etc., to identify the coupon hosting system 116 (i.e., the affiliate) to the retailer 112 in addition to facilitating communication between the web-enabled devices 106, coupon hosting system 116, and retailer 112. The retailer web server may include information, applications, modules, routines, instructions, etc., to facilitate an online purchase transaction including a coupon code, as further explained herein. Each web server 121, 122 may be a computing apparatus that includes a memory 121A, 122A to store the information, applications, etc., and a processor or controller 121B, 122B to execute the various applications, routines, modules, instructions, etc., as also described herein.

FIG. 1 also depicts one possible embodiment of the coupon hosting system 116. The coupon hosting system 116 may have a controller 124 operatively connected to the data warehouse 120 via a link 126 connected to an input/output (I/O) circuit 128. It should be noted that, while not shown, additional databases or data warehouses may be linked to the controller 124 in a known manner.

The controller 124 includes a program memory 130, the processor 118 (may be called a microcontroller or a microprocessor), a random-access memory (RAM) 132, and the input/output (I/O) circuit 128, all of which are interconnected via an address/data bus 134. It should be appreciated that although only one microprocessor 118 is shown, the controller 124 may include multiple microprocessors 118. Similarly, the memory of the controller 124 may include multiple RAMs 132 and multiple program memories 130. Although the I/O circuit 128 is shown as a single block, it should be appreciated that the I/O circuit 128 may include a number of different types of I/O circuits. The RAM(s) 132 and the program memories 130 may be implemented as semiconductor memories, magnetically readable memories, and/or optically readable memories, for example. A link 136 may operatively connect the controller 124 to the Internet 108 through the I/O circuit 128.

The coupon hosting system 116 may have various different structures and methods of operation. It should also be understood that while the embodiment shown in FIG. 1 illustrates some of the components and data connections that may be present in a coupon hosting system 116, it does not illustrate all of the data connections that may be present. For exemplary purposes, one design of a coupon hosting system is described herein, but it should be understood that numerous other designs may be utilized.

The program memory 130 may contain coupon hosting system (affiliate) data and objects 138 that may be displayed within a coupon hosting website 139 on a web-enabled computing device 106. One example of a coupon hosting system object 138 is a clickable object 138A that may be used to obscure a coupon code until a user's web browser cookie can be set, as described herein. A clickable object 138A may be any type of static or dynamic object that may include a graphic portion 138C and a plurality of instructions 138D. When executed, the plurality of instructions 138D may call functions that cause a processor 124 to perform various calculations, access local or remote data sources, execute local or remote functions, etc., when a user selects the object with a pointer or “clicks” on a graphic representation of the object. For example, the user may select of click the object 138A as represented by the graphic portion 138C within a web page displayed in a web browser 140 of a web-enabled computing device 106.

In some embodiments, the clickable object 138A is a JavaScript browser object (e.g., a button object, an area object, a text object, etc.) stored within the coupon hosting system 116 and delivered to a web-enabled computing device 106 via the network 108 in response to a user request. For example, a user attempting to access a web page may instantiate or launch a web browser 140 and enter a URL or other information that requests data from a remote computer (e.g., the system 116). The requested data may include a clickable object 138A as part of a request to the system 116 from the browser 140. The graphic portion 138C and the plurality of instructions 138D of the clickable object 138A also generally include configurable properties that determine how the clickable object 138A is displayed and what function may be called when the user clicks on it.

While the data and objects 138 of the coupon hosting system (affiliate) website 139 are depicted in FIG. 1 as including two objects 138A and 138B, the data and objects may include any number of objects to produce a coupon hosting system website 139 as described herein. Further, while FIG. 1 depicts the objects 138 and website 139 as being stored in a program memory 130, the objects 138 and website 139 may be stored remotely from the program memory 130, the system 116, or as part of a content delivery network 120A located at various points in the network 108.

By way of example and not limitation, the coupon hosting system data and objects 138, or the objects 138A and 138B may: hide one or more coupon codes on a coupon code hosting website 139; replace a visible portion of the coupon hosting website 136; call a function to cause a web browser cookie 144, 145 from one or more of the affiliate network 110 or the retailer 112, respectively, to be set on a user's web-enabled device 106; identify the origin of a coupon code to a retailer 112, affiliate network 110, or other entity; partially hide or partially reveal one or more coupon codes upon a “mouse over” or other pointer action; display instructions to the user for revealing one or more coupon codes; call a function to launch a retailer's website upon the user selecting a clickable object; place a previously hidden coupon code in a memory of the user's web-enabled computing device to allow the user to paste the code 302 in the coupon field on the retailer's website (e.g., a clipboard memory, etc.); etc. Using the data and objects 138, the coupon hosting system 116 may execute one or more of the various parts of the methods described herein with reference to the remaining Figures.

The web servers 110, 112 may each include a controller similar to the controller 124 described above with similar functionality and including data and objects to host a website (e.g., retailer's website 142). All servers may further include a display and a keyboard as well as a variety of other input/output devices (not shown) such as a scanner, printer, mouse, touch screen, track pad, track ball, isopoint, voice recognition system, digital camera, etc.

Various software applications and functions resident in the front-end components 102 and the back-end components 104 implement the coupon code referral methods, functions called by the clickable object 138A, and provide various user interface methods to allow users (i.e., customers and other parties to an online sale transaction, etc.) to access the system 100. One or more of the front-end components 102 and/or the back-end components 104 (e.g., the coupon hosting system 116) may include various video, image, and graphic design applications to permit the implementation of a coupon hosting website 139.

Each web-enabled device 106 may also include a user interface application that may be a web browser client 140 for accessing the coupon hosting system (affiliate) 116, affiliate network 110, and retailer 112 generally and the coupon hosting website 139, affiliate web server 121, and retailer website 142 in particular. In some embodiments, the web browser client 140 is an Internet Explorer web browser (produced by Microsoft Corporation of Redmond, Wash.) or the Firefox web browser (produced by the Mozilla Foundation of Mountain View, Calif.) to name only a few possible web browsers. The browser(s) 140 may be any type of web browsing client, including a proprietary client, and may communicate with the various servers 121, 122 and the coupon hosting system 116 using any type of protocol including, but not limited to, file transfer protocol (FTP), telnet, hypertext-transfer protocol (HTTP), etc.

Each browser may also include or have access to one or more cookies 144, 145 to be set before an affiliate receives credit for directing a customer to a retailer's website to conduct a sale transaction. The information sent to and from the servers 121, 122 and/or the coupon hosting system 116 may include data retrieved from the data warehouse 120, content delivery network (CDN)120A, and/or program memories 121A, 121B. The coupon hosting system 116 and/or the servers 121, 122 may implement any known protocol compatible with the website 139 accessed by the web-enabled devices 106 and adapted to the purpose of ensuring that the affiliate 116 receives credit for referring the user to the retailer.

The coupon and object data warehouse 120, the CDN 120A, and program memories 121A, 121B, may include graphics, text, and other objects for display within a coupon hosting system website 139, as described herein. For example, graphics may be provided by the system 100 for use within any portion of a website, URLs or other links to retailer websites 142, JavaScript browser object (e.g., buttons, etc.) or other interactive objects that, when activated by a user, may display other resources such as online coupon codes, or may perform any of the methods and functions described herein. As generally known in the art, the buttons may include text (some of which may serve as links and URLs to additional information and other websites), data entry boxes or text fields, pull-down lists, radio buttons, check boxes, and images. Throughout this specification, it is assumed that the buttons and clickable objects 138A refer to graphic elements that a user may activate using a mouse or other pointing device. Thus, throughout the specification, the terms “click” and “clicking” may be used interchangeably with the terms “select,” “activate,” or “submit” to indicate the selection or activation of one of the buttons or other display elements. Of course, other methods (e.g., keystrokes, voice commands, etc.) may also be used to select or activate the various buttons. Moreover, throughout this specification, the terms “link” and “button” are used interchangeably to refer to a graphic representation of a command that may call a method, function, or function block (i.e., the various “block #” as described below) including one or more instructions that are executed by a processor or controller by clicking on the command.

The methods for ensuring an affiliate 110 receives credit for referring customers to a retailer's website 142 may include one or more functions that may be stored as computer-readable instructions on a computer-readable storage medium, such as a program memory 130, or optical, magnetic, or flash memory, and may include the objects 138 and clickable objects 138A, as described herein. The instructions are generally described below as “blocks” or “function blocks” proceeding as illustrated in the flowcharts described herein. While the blocks of the flowcharts are numerically ordered and described below as proceeding or executing in order, the blocks may be executed in any order that would result in the coupon hosting system (affiliate) 116 receiving credit for referring a user to a retailer website 142 to complete a sale transaction, as described herein.

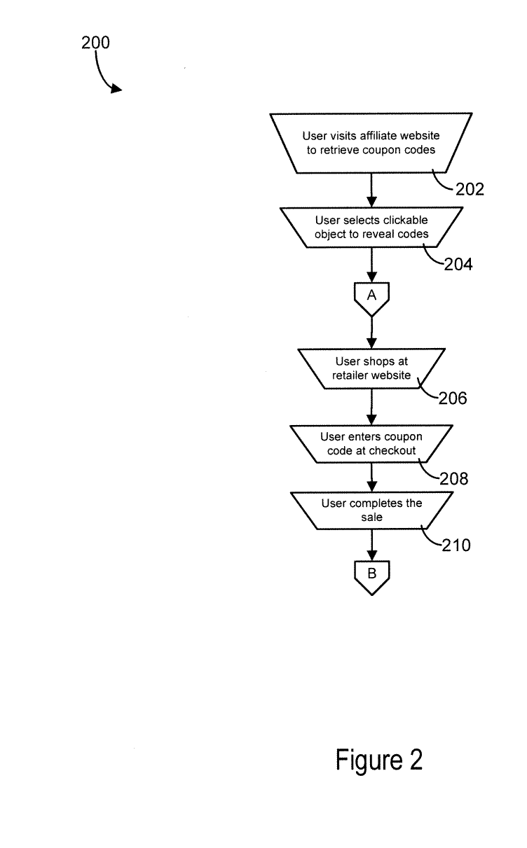

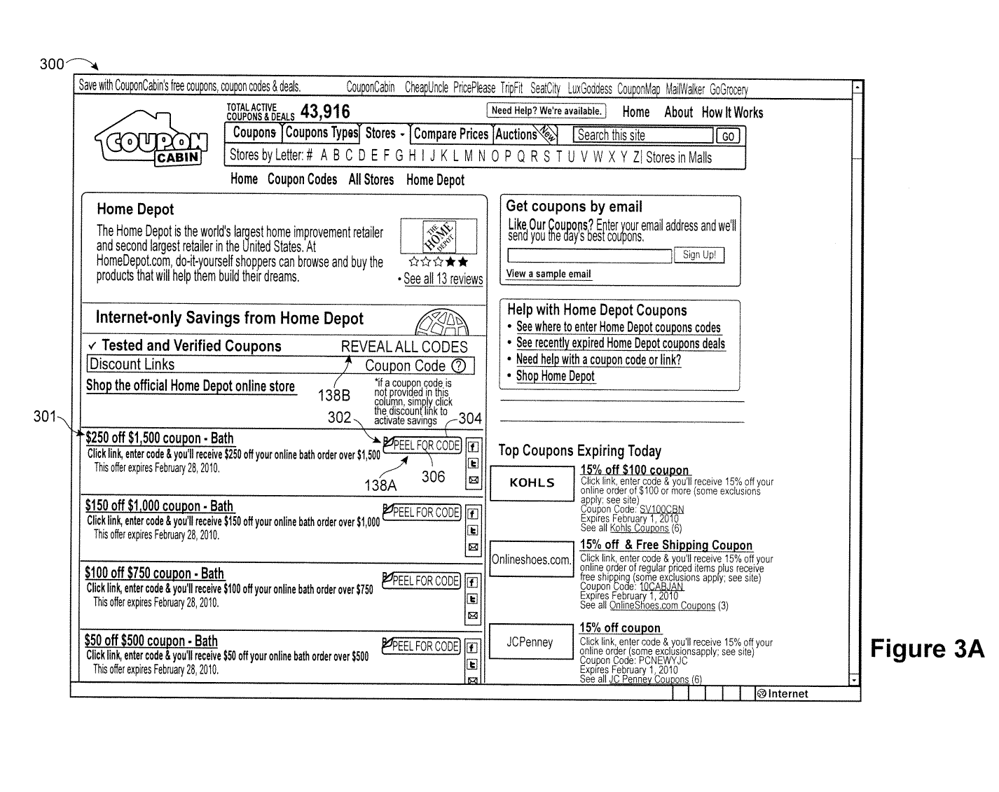

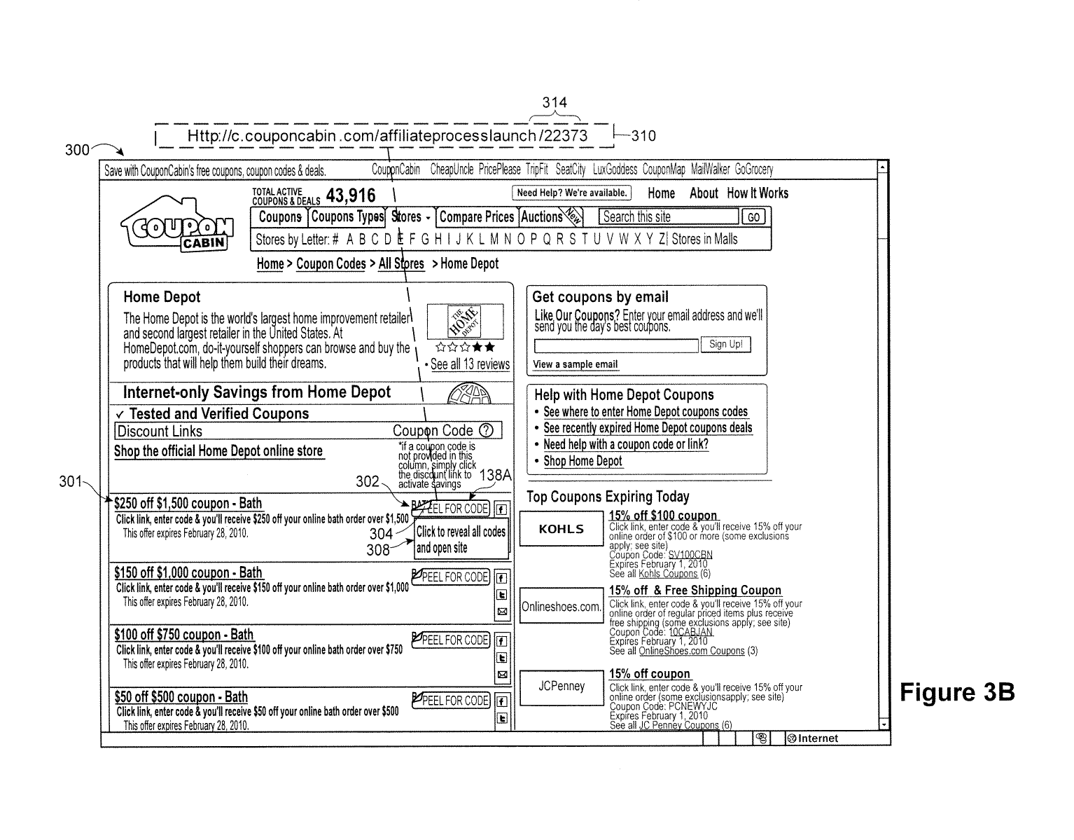

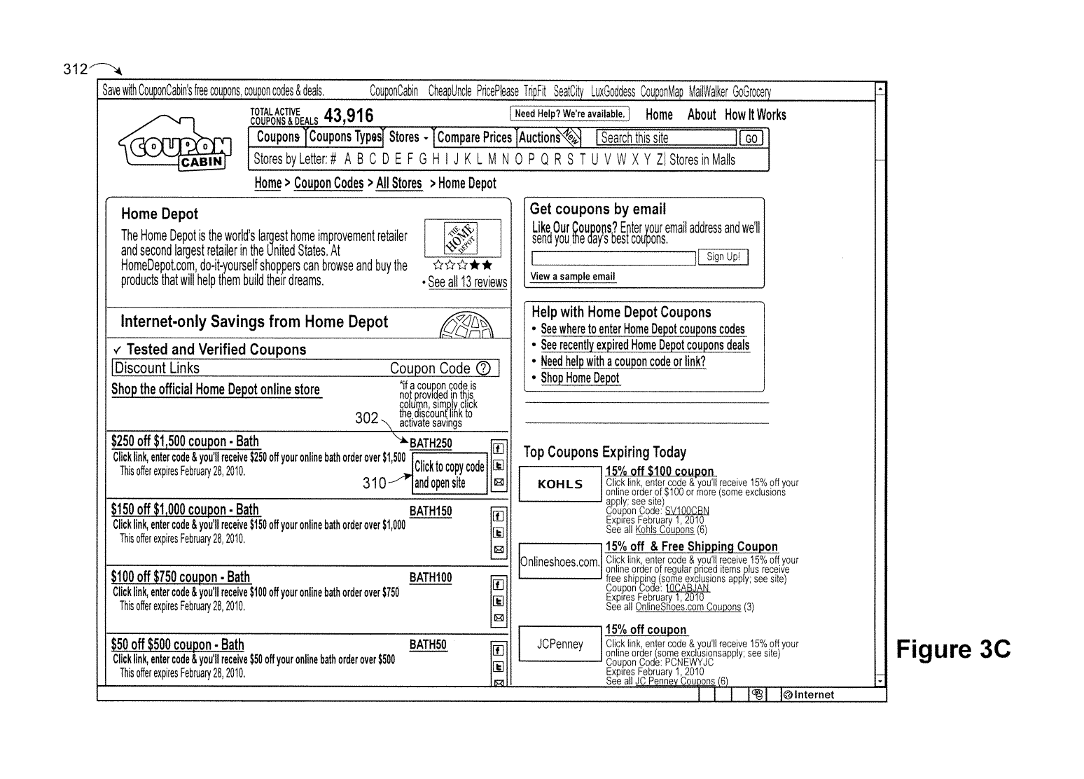

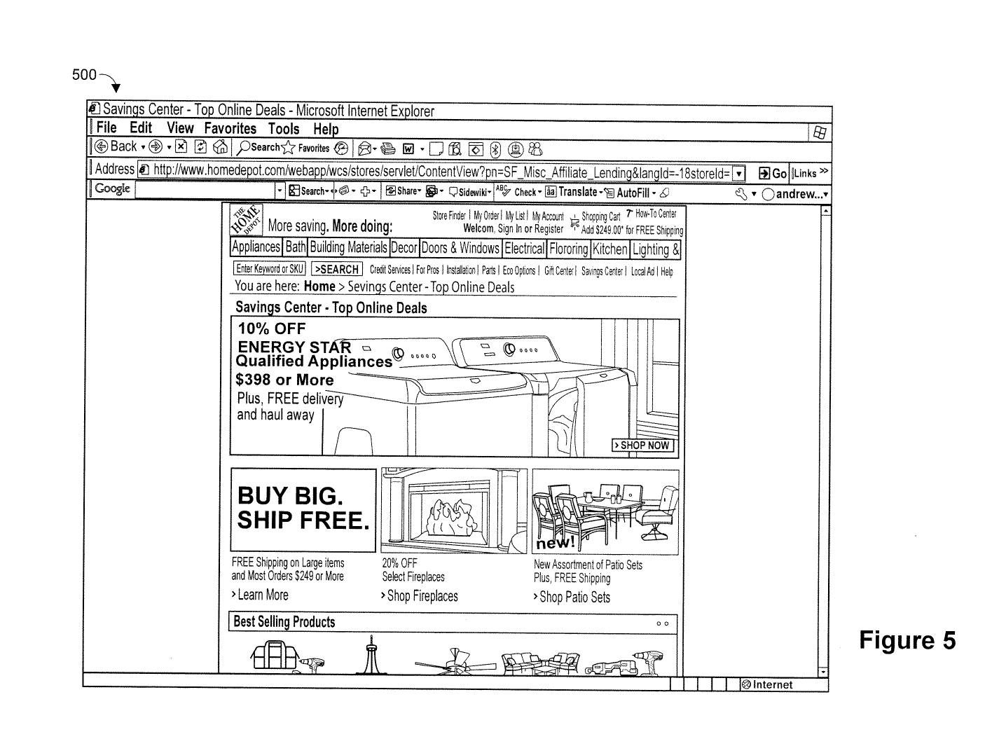

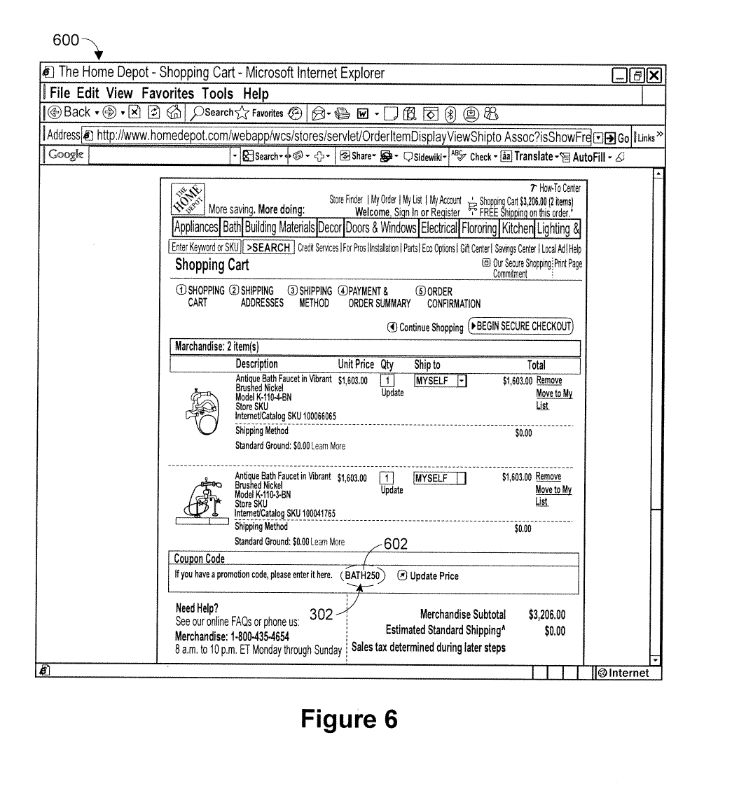

FIG. 2 illustrates one embodiment of a method 200 for ensuring that an affiliate receives credit for an online purchase transaction. At block 202, a user may access the Internet 108 to visit an affiliate website 139 to retrieve online purchase discount codes by requesting access to the website using a browser. The website 139 may include a plurality of web pages each made up of a plurality of objects (e.g., the objects 138 from FIG. 1) formatted using a hypertext language such as HTML, XHTML, etc., and may provide navigation to other web pages via hypertext links. FIG. 3A is an embodiment of a web page 300 from an affiliate or coupon hosting system website 139 that may be stored as a plurality of objects 138 within the coupon hosting system 116, the program memory 130, data warehouse 120, content delivery networks 120A, etc. The web page 300 may be retrieved from memory at a local computer (e.g., the data warehouse 120, the program memory 130, etc.) or from a remote web server (e.g., the content delivery network 120A). Web page 300 may be requested and served from a web server (e.g., the coupon hosting system 116) using Hypertext Transfer Protocol (HTTP). The web page 300 may include files of static text stored as one or more objects 138 within the coupon hosting system 116, or the system 116 may construct the (X)HTML for each web page when it is requested by the user's browser (i.e., dynamic web pages). The objects 138 may include client-side computer code or instructions such as JavaScript or code implementing Ajax techniques. These objects 138 or “scripts” may be provided by the coupon hosting system 116 as embedded in the HTML of the web page 300 or as separate, linked downloads specified in the web page 300 HTML. Further, these objects or scripts may run within the user's browser on the client computer, if the user allows. The above description of the affiliate website 139 and web pages applies equally to the retailer website 142 (and web pages 500 and 600 of FIGS. 5 and 6), and objects stored within or accessed by the affiliate network web server 121.

In some embodiments, the objects 138 within the web page 300 may include a discount link 301 and a clickable object 138A. The discount link may perform substantially similar methods and functions as described in relation to the clickable object 138A. The clickable object 138A may at least partially obscure a coupon code 302, or may be positioned in a visible area of the web page 300 where the coupon code 302 would normally be positioned until a user performs an action to ensure the affiliate receives credit for directing customers to a retailer's website. The clickable object 138A may include one or more of a graphic portion 304, a text portion 306, or any other visual element that at least partially obscures the coupon code 302 or an area of the web site 139 normally dedicated to displaying codes 302 (e.g., an animated graphic, a video, etc.) and, upon a user action (e.g., clicking or selecting the object 138A), may disappear to reveal a coupon code 302 or be replaced by a coupon code 302. The clickable object 138A may include several functions to ensure the affiliate coupon hosting system 116 receives credit for referring customers to a retailer's website 142 that is hosted on the retailer's web server 122 or other storage area accessible by the retailer's web server 122. For example, with reference to FIG. 3B, upon a “mouse over” or other user-initiated event (click, roll over, etc.), the clickable object 138A may display additional text 308 or other information to direct the user to further select or click the clickable object 138A. Also upon mouse over, the graphic portion 304 may be modified to reveal a further portion of the code 302 that is obscured by the clickable object 138A or to reveal another graphic.

At block 204, a user may click or select the clickable object 138A. Generally described, selecting the clickable object 138A (FIG. 3C) may remove the graphic and text portions of the clickable object 138A from the web page 300 to fully reveal the coupon code 302 underneath the clickable object or may cause the clickable object to be replaced by the coupon code 302. A mouse over or other action with the coupon code 302 may also reveal further instructions 310 or other information. More particularly, selecting the clickable object or the code 302 or link 138B (FIG. 3A) may launch an affiliate referral process 400 to ensure the affiliate gets credit for the transaction, as described below. In some embodiments, removing the graphic and text portions of the clickable object 138A may reveal the coupon code 302 on the same web page 300 that, before revealing the code, hid the coupon code 302, For example, instead of launching a new web page, accessing a new website, redirecting the user's browser away from the web site that displays the graphic and/or text portions 304, 306 of the clickable object, etc., the coupon code 302 may be revealed within the same web page 300 that previously displayed the displayed the graphic and/or text portions 304, 306 of the clickable object.

With reference to the Figures, an affiliate referral process 400 may begin with the customer or user selecting the clickable object 138A. The clickable object 138A may include an embedded URL 310 (FIG. 3B). Upon selection of the clickable object 138A, the embedded URL 310 may cause the user's browser 140 to remove the clickable object 138A from the web page 312 (FIG. 3C) and may also reveal the coupon codes 302 within the same web page 312 or a different web page, replace the clickable object 138A with the coupon codes 302 (block 204) within the same web page 312 or a different web page, and launch a web request to the affiliate network web server 121 at block 402. In some embodiments, the embedded URL may cause the user's browser 140 to redirect to an affiliate network web server 121, and reveal the codes 302 or replace the object 138A with a code 302 on the web page 312 or a different web page. Information within the embedded URL 310 of the clickable object may identify the affiliate to the affiliate web server 121. For example, the embedded URL 310 may include an identifying code 314 or other information indicating to the affiliate network 110, retailer, or other entity that the coupon hosting system (affiliate) 116 was the source of the referral to the retailer 112. In some embodiments, the identifying code 314 may also be used to identify an online sale transaction that results from the user's selection of the clickable object 138A. At block 402, the controller or processor 121B of the affiliate network web server 121 may receive, through the Internet 108, an instruction including the identifying code 314 as input for a function to be executed by the controller or processor 121B.

Using the identifying code 314, the processor or controller of the affiliate network web server 121 may then execute one or more instructions stored in the memory 121A (or elsewhere) to set an affiliate network's cookie 144 on the user's computer at block 404. As described above, the value of the affiliate network's cookie 144 identifies both the affiliate network 110 and the affiliate 116 to the retailer. In some embodiments, the processor or controller of the affiliate network web server 121 uses the identifying code 314 to generate the value of the affiliate network's cookie 144. Thus, the identifying code 314 and the value of the affiliate network's cookie 144 may be different values (e.g., a hash of the identifying code 314, an encoded version of the identifying code, etc.) In further embodiments, the processor or controller of the affiliate network web server 121 uses the identifying code 314 as the value of the affiliate network's cookie 144. Thus, the identifying code 314 and the value of the affiliate network's cookie 144 may be identical.

At block 406, the affiliate network 110 or the coupon hosting system (affiliate) 116 may send a redirect command via the Internet 108 to the user's browser 140 to redirect the user's browser 140 to the retailer's website 142 stored on the retailer's web server 122. Optionally or additionally, selecting the clickable object 138A may cause a function to be called to set a retailer's cookie 145 on the user's web-enabled device 106 at block 407. As with the affiliate network's cookie 144 set at block 404, above, the retailer's cookie 145 may inform the retailer of both the affiliate network 110 and the affiliate 116.

At block 408, upon accessing a page of the retailer's website 500 (FIG. 5), the retailer's web server processor 122B may execute one or more instructions stored in the web server memory 122A to read a retailer's cookie 145 on the user's web-enabled device. In some embodiments, the instructions may read one or both of the affiliate network's cookie 144 and the retailer's cookie 145. For example, the retailer web server 122 may send one or more commands to the user's web-enabled device 106 to read the affiliate network's cookie 144 set by block 404. Additionally or alternatively, the retailer web server 122 may send one or more commands to the user's web-enabled device 106 to read the retailer's cookie 145 set by block 407. If retailer web server 122 discovers the set affiliate network's cookie 144, then the retailer web server 122 associates an indication of the affiliate network 110 with a record of any sale transaction that results from the referral to the retailer 112. The affiliate network 110 is then able to credit the coupon hosting system 116 (affiliate) with the sale. If the retailer web server 122 discovers the set retailer's cookie 145, then the retailer web server 122 associates an indication of the coupon hosting system 116 (affiliate) with a record of any sale transaction that results from the referral to the retailer 112. The coupon hosting system 116 (affiliate) is then credited with the sale. The indication of the affiliate network and affiliate's association with the transaction record may be stored within the memory 122A or any other memory as described herein. From the stored indication and transaction record, the affiliate network 110 and the coupon hosting system 116 may receive a sales commission according to terms of any agreement between the coupon hosting system (affiliate) 116, affiliate network 110, and retailer 112.

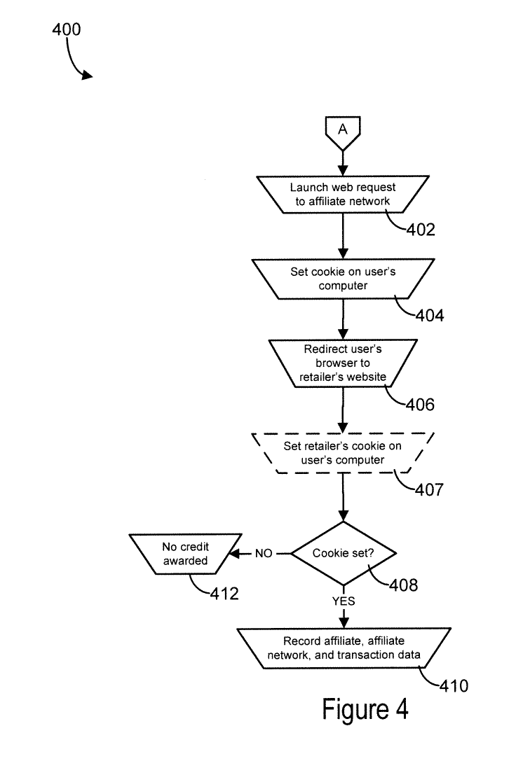

If, however, the cookie 144, 145 has not been set, then the retailer's web server 122 cannot determine which affiliate 116 or affiliate network 110 facilitated the transaction and no credit is awarded at block 412. Alternatively, the coupon hosting system 116 web page 300 may include another object (e.g., a hypertext link 138B, FIG. 3A), that removes the clickable object 138A from the coupon codes 302 or from the web page 300 generally to reveal all of the codes 302 with or without launching the affiliate referral process described above and setting the cookie as described in relation to block 404 (FIG. 4).

Returning to the method 200 of FIG. 2, the user shops at the retailer's website 500 at block 206 and, as part of the checkout process web page 600, enters the coupon code 302 into a field 602 during the checkout process at block 208. In some embodiments, the user manually enters the coupon code 302 into the field during the checkout process, while in other embodiments, the code is placed on the clipboard of the user's web-enabled device to be pasted into the field by the user during checkout. At block 210, the user completes the sale.

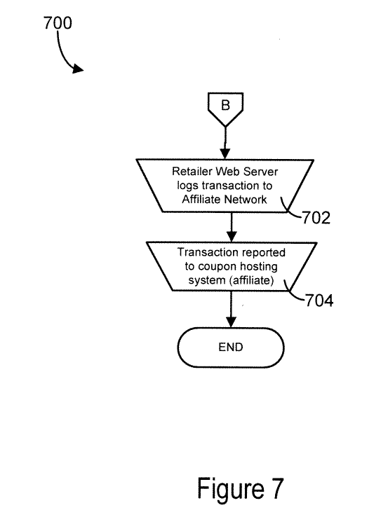

With reference to FIG. 7, once the user completes the sale transaction, the retailer web server 122 logs the sale back to the affiliate network web server 121 at block 702. At block 704, the affiliate network server 121 may report the completed sale back to the coupon hosting system (affiliate) 116.

Once the transaction has been reported to the coupon hosting system 116, the affiliate network 110 and the coupon hosting system (affiliate) 116 may earn a percentage commission on the completed sale. Thus, a clickable object 138A hides the coupon code 302 or is positioned in an area normally occupied by the coupon code 302 until the clickable object 138A is selected, revealing the code(s) and launching the process described in FIG. 4 resulting in a cookie 144, 145 on the user's web-enabled device 106 that associates one or more of the affiliate and affiliate network with the user's online sale transaction. Once the cookie is set, both the affiliate 116 and affiliate network 110 may be identified to receive commission credit for the sale.

This detailed description is to be construed as exemplary only and does not describe every possible embodiment, as describing every possible embodiment would be impractical, if not impossible. One could implement numerous alternate embodiments, using either current technology or technology developed after the filing date of this provisional patent application.

We claim:

1. An affiliate marketing system configured to associate a coupon hosting system with an online sale transaction originating from a retailer website displayed on a web-enabled computing device, the sale transaction using a coupon code from the coupon hosting system, the system comprising:
a program memory;
a processor; and
a clickable object including a graphic portion, an identifying code, and a plurality of instructions stored in the program memory, the identifying code corresponding to the coupon hosting system and the plurality of instructions executed by the processor to:
at least partially hide the coupon code on a web page using the graphic portion, the web page hosted by the coupon hosting system and displayed on the web-enabled computing device;
launch a web request to an affiliate network server, the web request including the identifying code;
cause a cookie to be set on the web-enabled computing device, the cookie including a value identifying the coupon hosting system; and
reveal the coupon code on the web page after the cookie is set.

2. The affiliate marketing system of claim 1, wherein the clickable object includes an embedded URL, the embedded URL includes the identifying code, and the web request includes the embedded URL.

3. The affiliate marketing system of claim 1, wherein the plurality of instructions are further executed by the processor to launch a website of the retailer upon selection of the graphic portion.

4. The affiliate marketing system of claim 3, wherein the value of the set cookie is readable to associate the coupon hosting system with the online sale transaction, and the online sale transaction originates with the retailer website.

5. The affiliate marketing system of claim 4, wherein the retailer web server associates an indication of the affiliate network with a record of the sale transaction originating from the website of the retailer and the affiliate network credits the coupon hosting system with the online sale transaction.

6. The affiliate marketing system of claim 5, wherein the affiliate network server reports the sale transaction back to the coupon hosting system.

7. The affiliate marketing system of claim 1, wherein the cookie is set using the affiliate network server.

8. The affiliate marketing system of claim 1, wherein the identifying code also identifies the affiliate network.

9. The affiliate marketing system of claim 1, wherein the plurality of instructions are further executed by the processor to place the coupon code in a memory of the web-enabled computing device.

10. The affiliate marketing system of claim 1, wherein the web page revealing the coupon code after the cookie is set is the web page that, previously, at least partially hid the coupon code.

11. A method for crediting an online sale transaction to a coupon hosting system, the sale transaction originating from a retailer website displayed on a web-enabled computing device, the sale transaction using a coupon code from the coupon hosting system, the method comprising:
at least partially hiding the coupon code on a web page of the coupon hosting system using a graphic portion of a clickable object, the web page displayed on the web-enabled computing device;
launching a web request to an affiliate network server upon selection of the graphic portion of the clickable object, the web request including an identifying code corresponding to the coupon hosting system;
causing a cookie to be set on the web-enabled computing device, the cookie including a value identifying the coupon hosting system; and
revealing the coupon code on the web page after setting the cookie.

12. The method of claim 11, wherein the clickable object includes an embedded URL, the embedded URL includes the identifying code, and the web request includes the embedded URL.

13. The method of claim 11, further comprising launching a website of the retailer upon selection of the graphic portion.

14. The method of claim 13, wherein the value of the set cookie is readable to associate the coupon hosting system with the online sale transaction, and the online sale transaction originates with the retailer website.

15. The method of claim 14, wherein the retailer web server associates an indication of the affiliate network with a record of the sale transaction originating from the website of the retailer and the affiliate network credits the coupon hosting system with the online sale transaction.

16. The method of claim 15, further comprising reporting the sale transaction back to the coupon hosting system.

17. The method of claim 11, wherein the cookie is set using the affiliate network server.

18. The method of claim 11, wherein the identifying code also identifies the affiliate network.

19. The method of claim 11, further comprising placing the coupon code in a clipboard memory of the web-enabled computing device.

20. The method of claim 10, wherein the web page revealing the coupon code after the cookie is set is the web page that, previously, at least partially hid the coupon code.

21. A computer-readable storage medium comprising computer-executable instructions to associate a coupon hosting system with an online sale transaction originating from a retailer website displayed on a web-enabled computing device, the sale transaction using a coupon code from the coupon hosting system, the system comprising, the instructions to:
at least partially hide the coupon code on a web page using a graphic portion of a clickable object, the web page hosted by the coupon hosting system and displayed on the web-enabled computing device;
launch a web request to an affiliate network server upon selection of the graphic portion of the clickable object, the web request including an identifying code corresponding to the coupon hosting system;
cause a cookie to be set on the web-enabled computing device, the cookie including a value identifying the coupon hosting system to a retailer; and
reveal the coupon code on the web page after setting the cookie.

22. The computer-readable storage medium of claim 21, further comprising instructions to launch a website of the retailer upon selection of the graphic portion.

23. The computer-readable storage medium of claim 22, wherein the value of the set cookie is readable to associate the coupon hosting system with the online sale transaction, and the online sale transaction originates with the retailer website.

24. The computer-readable storage medium of claim 23, further comprising instructions to associate an indication of the affiliate network with a record of the sale transaction originating from the website of the retailer and the affiliate network credits the coupon hosting system with the online sale transaction.

25. The computer-readable storage medium of claim 21, further comprising instructions to place the code in a clipboard memory of the web-enabled computing device.

26. The computer-readable storage medium of claim 21, wherein the web page revealing the coupon code after the cookie is set is the web page that, previously, at least partially hid the coupon code.

27. An affiliate marketing system configured to obscure a coupon code displayed on a web page of a coupon hosting system until a web request to an online retailer is initiated, the online retailer corresponding to the coupon code, the system comprising:
a program memory;
a processor; and
a clickable object including a graphic portion and a plurality of instructions stored in the program memory, the plurality of instructions executed by the processor to:
at least partially hide the coupon code on the web page of the coupon hosting system using the graphic portion, the web page displayed on a web-enabled computing device;
reveal the coupon code on the web page upon selection of the graphic portion of the clickable object; and
launch a web request to a retailer web server, the web request including a code identifying one or more of the online sale transaction and the coupon hosting system.

28. The affiliate marketing system of claim 27, wherein the plurality of instructions are further executed by the processor to copy the coupon code to a clipboard memory of the web-enabled computing device upon selection of another graphic portion.

29. The affiliate marketing system of claim 28, wherein a memory of the web-enabled computing device includes a clipboard.

30. The affiliate marketing system of claim 28, the web request results in the online sale transaction at the web-enabled computing device.

31. The affiliate marketing system of claim 30, wherein the web request includes an identifying code corresponding to the coupon hosting system and the plurality of instructions are further executed by the processor to use the identifying code to credit the coupon hosting system with the online sale transaction.

32. A method of obscuring a coupon code displayed on a website of a coupon hosting system until initiating a web request to an online retailer corresponding to the coupon code, the method comprising:
at least partially hiding the coupon code on the web page of the coupon hosting system using a graphic portion of a clickable object, the web page displayed on a web-enabled computing device;
revealing the coupon code on the web page upon selection of the graphic portion of the clickable object; and
launching a web request to a retailer web server, the web request including a code identifying one or more of the online sale transaction and the coupon hosting system.

33. The method of claim 32, further comprising copying the coupon code to a clipboard memory of the web-enabled computing device upon selection of another graphic portion.

34. The method of claim 33, wherein a memory of the web-enabled computing device includes a clipboard.

35. The method of claim 33, wherein the web request results in the online sale transaction at the web-enabled computing device.

36. The method of claim 35, wherein the web request includes an identifying code corresponding to the coupon hosting system and the method further comprises using the identifying code to credit the coupon hosting system with the online sale transaction.

37. A computer-readable storage medium comprising computer-executable instructions to obscure a coupon code displayed on a web page of a coupon hosting system until a web request to an online retailer is initiated, the online retailer corresponding to the coupon code, the instructions to:
at least partially hide the coupon code on the web page of the coupon hosting system using a graphic portion of a clickable object, the web page displayed on a web-enabled computing device;
reveal the coupon code on the web page upon selection of the graphic portion of the clickable object; and
launch a web request to a retailer web server, the web request including a code identifying one or more of the online sale transaction and the coupon hosting system.

38. The computer-readable storage medium of claim 37, further comprising instructions to copy the coupon code to a clipboard memory of the web-enabled computing device upon selection of another graphic portion.

39. The computer-readable storage medium of claim 38, wherein a memory of the web-enabled computing device includes a clipboard.

40. The computer-readable storage medium of claim 38, wherein the web request results in the online sale transaction at the web-enabled computing device.

41. The computer-readable storage medium of claim 40, wherein the web request includes an identifying code corresponding to the coupon hosting system and the medium further comprises instructions to use the identifying code to credit the coupon hosting system with the online sale transaction.
